(19) United States
(12) Patent Application Publication
(10) Pub. No.: US 2008/0248351 A1
(43) Pub. Date: Oct. 9, 2008

(54) Fuel Cell System

(75) Inventors: Chihiro Wake, Saitama (JP); Jumpei Ogawa, Saitama (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/098,231

(22) Filed: Apr. 4, 2008

(30) Foreign Application Priority Data
Apr. 6, 2007 (JP) JP 2007-100783

(51) Int. Cl. H01M 8/04; H01M 10/46

(52) U.S. Cl. 429/24; 320/101

(57) ABSTRACT

The object of the present invention is to provide a fuel cell system enabling reliable startup thereof, even below the freezing point. The fuel cell system 1 is provided with a startup electric power calculation portion 71 for calculating electric power required for allowing an auxiliary device 50 to startup the fuel cell; an available electric power calculation portion 72 calculating the available electric power of the high voltage battery 22; and an auxiliary device electric power control means 73 for judging whether the available electric power exceeds the startup electric power, supplying electric power to the auxiliary device 50 to startup the fuel cell 10 when the available electric power is greater than the startup electric power, and cancelling startup of the fuel cell when the available electric power is not greater than the startup electric power.

This application is based on and claims the benefit of priority from Japanese Patent Application No. 2007-100783, filed on 6 Apr. 2007, the content of which is incorporated herein by reference.

### BACKGROUND OF THE INVENTION

1. Field of the Invention

The present invention relates to a fuel cell system. Specifically, the present invention relates to a fuel cell system enabling startup below the freezing point.

2. Related Art

Recently, fuel cell systems have drawn attention as new sources of power that can be used to drive vehicles. For example, a fuel cell system can be provided with a fuel cell producing electric power from chemical reactions of reactive gas, a reactive gas supply device supplying reactive gas to the fuel cell through a reactive gas channel, and a control device controlling the reactive gas supply device.

The fuel cell can be structured to include a plurality, e.g., tens or hundreds, of stacked cells. In such an example, each cell is configured with a membrane electrode assembly (MEA) placed between a pair of plates. The MESA is configured with two electrodes, such as an anode (i.e., a positive electrode) and a cathode (i.e., a negative electrode), and a solid polymer electrolyte membrane placed between these electrodes.

By supplying hydrogen gas as reactive gas to the anode of the fuel cell and oxygenated air as reactive gas to the cathode of the fuel cell, electric power is produced by an electrochemical reaction. Since only water, which is essentially harmless to the environment, is generated during power production, the fuel cell has garnered attention from the viewpoint of environmental impact, and efficiency of use.

However, in such a fuel cell system, under a condition in which power generation is stopped by stopping the supplying of hydrogen gas and air, differential pressure between both electrodes is generated. Then, impurities such as nitrogen contained in air supplied to the cathode side flow into the anode side, whereby the hydrogen concentration in the anode channel is reduced. Thus, when the fuel cell system is started, substitution of the gas retained in the anode channel with newly supplied hydrogen, which is so-called “OCV check”, is performed in order to increase the concentration of hydrogen in the anode channel (see Japanese Unexamined Patent Application Publication No. 2003-331888). Specifically, this OCV check is performed by adjusting the opening of a purge valve on the anode channel, while supplying hydrogen until the open voltage of the fuel cell exceeds the predetermined threshold.

Accordingly, by performing the OCV check in preparation for startup electric power generation by the fuel cell, the fuel cell system can be started up reliably, for example, even after being left to stand for a long time without having been started.

### SUMMARY OF THE INVENTION

When the abovementioned OCV check is performed, the electric power required for detecting the open voltage of the fuel cell and driving a purge valve and auxiliary devices for supplying hydrogen is supplied from a battery charged by the fuel cell when the fuel cell system was started a previous time.

FIG. 11 is a diagram showing the temperature characteristics of this battery. As shown in FIG. 11, the internal resistance of the battery increases as the temperature of the battery decreases. Particularly, when the temperature of the battery is below the freezing point, the internal resistance increases greatly.

FIG. 12 is a diagram showing the change of the battery voltage when the battery drives the auxiliary devices. In FIG. 12, the continuous line 91 represents the change of the battery voltage at a normal temperature (e.g., 30° C.), and the broken line 92 represents that below the freezing point (e.g., −10° C.).

As shown in FIG. 12, when the auxiliary device begins to be driven, for example, at 10 kW, IR drop occurs because of the internal resistance, thereby decreasing the battery voltage. As described above, the internal resistance of the battery is greatly increased below the freezing point, whereby the battery voltage is decreased more greatly upon driving of the accessories below the freezing point than at a normal temperature. Accordingly, the battery voltage decreases below the lower limit required to start the fuel cell system when the temperature of the battery is below the freezing point, so that the fuel cell system may not be started.

The object of the present invention is to provide a fuel cell system able to startup reliably, even below the freezing point.

The fuel cell system of the present invention is characterized by including: a fuel cell (e.g., fuel cell 10) producing electric power by a reaction of reactive gas (e.g., hydrogen gas and air as described below); an auxiliary device (e.g., an auxiliary device 50) driving the fuel cell; an electrical storage device (e.g., high voltage battery 22) storing at least a portion of the electric power produced by the fuel cell; a control means (e.g., control device 70) for supplying electric power stored in the electrical storage device to the auxiliary device to startup the fuel cell when the fuel cell is started; and an electrical storage device temperature detection means (e.g., battery temperature sensor 223) for detecting or estimating the temperature of the electrical storage device; in which the control means includes: a startup electric power calculation means (e.g., startup electric power calculation portion 71) for calculating an amount of startup electric power which is an amount of electric power required for the auxiliary device to startup the fuel cell; an available electric power calculation means (for example, available electric power calculation portion 72) for calculating an amount of available electric power which is an amount of electric power available from the fuel cell; and an auxiliary device electric power control means (auxiliary device electric power control portion 73) for judging whether or not the amount of available electric power exceeds the amount of startup electric power, supplying electric power to the auxiliary device to startup the fuel cell when the amount of available electric power is greater than the amount of startup electric power, and cancelling startup of the fuel cell when the amount of available electric power is not greater than the amount of startup electric power; in which the auxiliary device electric power control means limits electric power to be supplied to the auxiliary device based on a temperature detected by the electrical storage device temperature detection means in case where the fuel cell is started.

As described above, the internal resistance of the electrical storage device is increased as the temperature of the electrical storage device decreases. For example, in a case where the electrical storage device is a power source below the freezing temperature, when the electric power consumption increases, the consumption due to the internal resistance is increased. Thus, the amount of available electric power in the electrical storage device is decreased.

According to the present invention, the fuel cell system is provided with the auxiliary device electric power control means for limiting the electric power consumed by the auxiliary device to startup the fuel cell, based on the temperature of the electrical storage device. For example, when the temperature of the electrical storage device is below the freezing point, the auxiliary device is driven within the range of the amount of the electric power available in the electrical storage device by limiting the electric power consumed in the auxiliary device by the auxiliary device electric power control means, so that the fuel cell system can be started up reliably.

In this case, it is preferable that the fuel cell system further includes an electric power detection means (e.g., battery electric power sensor 224) for detecting electric power output from the electrical storage device; in which the auxiliary device electric power control means sets the upper limit of electric power based on the temperature detected by the electrical storage device temperature detection means, and controls the electric power to be supplied to the auxiliary device so that electric power detected by the electric power detection means is less than the upper limit of electric power.

According to the present invention, electric power consumed by the auxiliary device is controlled by the auxiliary device electric power control means so that the electric power consumed by the auxiliary device is lower than the upper limit of electric power set based on the temperature of the electrical storage device. For example, in a case where the temperature of the electrical storage device is below the freezing point, the fuel cell system can be started up reliably, by setting the upper limit of electric power so that the voltage of the electrical storage device is not lower than the lower limit required for startup of the fuel cell system.

In this case, it is preferable that the fuel cell system further includes a voltage detection means (e.g., battery voltage sensor 221) for detecting the voltage of the electrical storage device; in which the auxiliary device electric power control means controls voltage to be supplied to the auxiliary device so that the voltage detected by the voltage detection means is more than the predefined lower limit of voltage.

According to the present invention, electric power consumed by the auxiliary device is controlled by the auxiliary device electric power control means so that the voltage of the electrical storage device is greater than the predetermined lower limit. For example, the fuel cell system can be started up reliably by setting the lower limit of the voltage of the electrical storage device to the lower limit required to at least startup the fuel cell system when being started up. In addition, an optimum amount of electric power can be supplied within the range for start up of the fuel cell system by controlling electric power consumed by the auxiliary device based on the lower limit of the voltage of the electrical storage device, so that the startup time of the fuel cell system can be shortened.

In this case, it is preferable that the auxiliary device includes a reactive gas supply means for supplying reactive gas.

According to the present invention, the auxiliary device electric power control means limits electric power consumed by the reactive gas supply means based on the temperature of or around the electrical storage device. Accordingly, although it takes longer to startup the fuel cell system in a case where reactive gas is supplied when the fuel cell system is start up below the freezing point, compared to when electric power is not limited, the auxiliary device can be driven within the range of the electric power available in the electrical storage device to startup the fuel cell system reliably. In addition, noise that may be generated when the reactive gas supply means is driven can be reduced by limiting electric power consumed by the reactive gas supply means.

In this case, it is preferable that the electrical storage device temperature detection means detects the temperature of the fuel cell or the auxiliary device, and then estimates the temperature of the electrical storage device based on the detected temperature.

According to the present invention, the temperature of the electrical storage device can be determined without being provided with a sensor to directly detect the temperature of the electrical storage device.

According to the present invention, the fuel cell system is provided with the auxiliary device electric power control means for Limiting electric power consumed by auxiliary device to startup a fuel cell based on the temperature of or around the electrical storage device. For example, when the temperature of the electrical storage device is below the freezing point, the auxiliary device is driven within the range of the electric power available in the electrical storage device, by limiting electric power consumed by the auxiliary device by the auxiliary device electric power control means so that the fuel cell system can be started up reliably.

### BRIEF DESCRIPTION OF THE DRAWINGS

FIG. 1 is a block diagram of the fuel cell system according to a first embodiment of the present invention;

FIG. 2 is a block diagram of a control device of the fuel cell system of the first embodiment;

FIG. 3 shows a graph illustrating the relationship between the state-of-charge and the available electric power of the high voltage battery of the first embodiment;

FIG. 4 is a graph illustrating a relationship between the temperature of the fuel cell and the target pressure in the air supply channel in the first embodiment;

FIG. 5 shows a graph indicating the relationship between the temperature of the high voltage battery and the upper limit of electric power to be supplied to the auxiliary device in the first embodiment;

FIG. 6 is a flowchart showing the procedure from startup to stop of the fuel cell of the first embodiment;

FIG. 7 is a flow chart showing the procedure of the OCV check processing at low temperature in the first embodiment;

FIG. 8 is a timing chart showing the performance of the fuel cell system of the first embodiment;

FIG. 9 is a block diagram of the control device in the fuel cell system according to a second embodiment of the present invention;

FIG. 10 is a flow chart showing the procedure of the OCV check processing at low temperature in the second embodiment;

FIG. 11 is a graph showing the temperature characteristic of the battery; and

FIG. 12 is a graph showing the voltage change of the battery.

### DETAILED DESCRIPTION OF THE INVENTION

The embodiments of the present invention are described below with reference to the accompanying drawings.

### First Embodiment

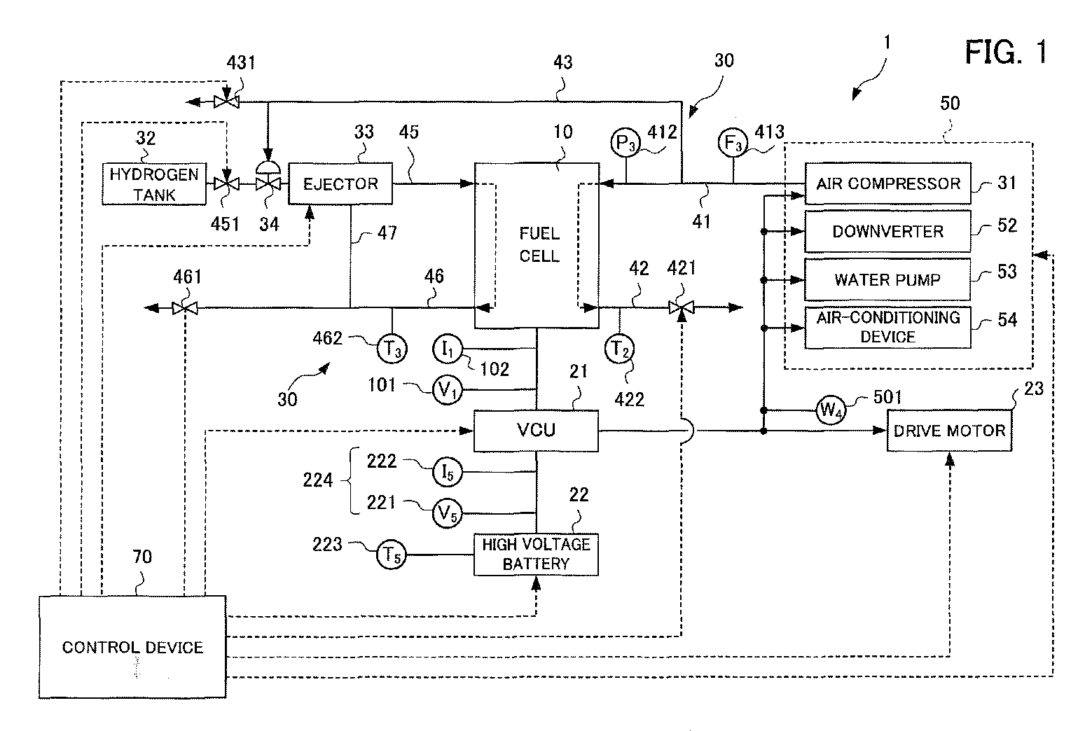

FIG. 1 is a block diagram of the fuel cell system 1 according to the first embodiment of the present invention.

The fuel cell system 1 includes a fuel cell 10, a supply device 30 supplying reactive gas such as hydrogen gas and air to the fuel cell 10, an auxiliary device 50 driving the fuel cell 10 and the supply device, and a control device 70 controlling the fuel cell 10, the supply device, and the auxiliary device 50 as the control means.

The fuel cell 10 can be configured by including a plurality (e.g., tens or hundreds) of stacked cells. In such an example, each cell is configured with a membrane electrode assembly (MEA) placed between a pair of plates. The MEA is configured with two electrodes, such as an anode (i.e., a positive electrode) and a cathode (i.e., a negative electrode), and a solid polymer electrolyte membrane held between these electrodes. Generally, these electrodes are formed from a catalyst layer in contact with the solid polymer electrolyte membrane at which oxidation and reduction reactions occur, and a gas dispersion layer in contact with the catalyst layer.

A supply of hydrogen gas to the anode (positive electrode) and air to the cathode (negative electrode), causes an electrochemical reaction from which the fuel cell 10 produces electric power. The fuel cell 10 is connected to a fuel cell voltage sensor 101 and a fuel cell current sensor 102 detecting the output voltage (V1) and the current (11) of the fuel cell 10, respectively.

The supply device 30 is configured by including an air compressor 31 as the reactive gas supply means for supplying air to the cathode side of the fuel cell 10, a hydrogen tank 32 and an ejector 33 supplying hydrogen gas to the anode side of the fuel cell 10, and a regulator 34 controlling the pressure of hydrogen gas supplied from the hydrogen tank 32.

The air compressor 31 is connected to the cathode side of the fuel cell 10 through an air supply channel 41. An air discharge channel 42 is connected to the cathode side of the fuel cell 10, while the end of the air discharge channel 42 is connected to the emission gas process device (not shown) through a back pressure valve 421. An air supply channel pressure sensor 412 detecting the pressure (P3) in the air supply channel 41 and an air supply channel flow sensor 413 detecting the flow (F3) in the air supply channel 41 are provided in the air supply channel 41. In addition, an air discharge channel temperature sensor 422 detecting the temperature (T2) of air in the air discharge channel 42 is provided between the fuel cell 10 and a back pressure valve 421 in the air discharge channel 42.

An air connection channel 43, which branches off from the air supply channel 41, is provided in the air supply channel 41, while the end of this air connection channel 43 is connected to the regulator 34. In addition, an air release valve 431, which releases air in the air connection channel 43, is provided in the air connection channel 43. The air release valve 431, which is a flow control valve, can control the pressure of air in the air connection channel 43 by adjusting the opening thereof.

The hydrogen tank 32 is connected to the anode side of the fuel cell 10 through a hydrogen supply channel 45. The regulator 34 and the ejector 33 are provided in the hydrogen supply channel 45. In addition, an isolation valve 451 opening and closing the hydrogen supply channel 45 is provided between the hydrogen tank 32 and the regulator 34 in this hydrogen supply channel 45.

A hydrogen discharge channel 46 is connected to the anode side of the fuel cell 10, while the end of the hydrogen discharge channel 46 is connected to the above-mentioned emission gas process device. This emission gas process device dilutes hydrogen gas discharged from the hydrogen discharge channel 46 into air discharged from the air discharge channel 42.

A recirculation channel 47, which branches off from the hydrogen discharge channel 46, is provided in the hydrogen discharge channel 46, while the end of the recirculation channel 47 is connected to the ejector 33. Accordingly, the recirculation channel 47 supplies hydrogen gas, which was discharged from the fuel cell 10 to the hydrogen discharge channel 46, to the fuel cell 10 through the ejector 33 again. In this hydrogen discharge channel 46, a purge valve 461, which discharges gas that flows in the recirculation channel 47, is provided between the end of the hydrogen discharge channel 46 and the branching point of the recirculation channel 47. In addition, a hydrogen discharge channel temperature sensor 462 detecting the temperature (T3) of gas in the hydrogen discharge channel 46 is provided between the branching point of the recirculation channel 47 and the fuel cell 10 in the hydrogen air discharge channel 46.

The ejector 33 collects hydrogen gas discharged in the hydrogen discharge channel 46 through the recirculation channel 47 and supplies the hydrogen gas to the fuel cell 10 again, thereby circulating.

The regulator 34, which is a so-called proportioning pressure control valve, controls the opening thereof depending on the pressure of air in the air connection channel 43 referred to as a signal pressure. The regulator 34 opens the opening thereof wider as the pressure in the air connection channel 43 increases. In other words, the pressure of gas in the hydrogen supply channel 45 can be adjusted by driving the air compressor 31 to control the pressure of air in the air connection channel 43.

The auxiliary device 50 is configured by including the abovementioned air compressor 31, a downverter 52, a water pump 53 pumping a coolant to cool the fuel cell 10, and an air conditioner 54. In addition, the auxiliary device 50 is connected to the auxiliary device power consumption sensor 501, which detects electric power W4 consumed by the auxiliary device 50.

The water pump 53 circulates the coolant in a circulating channel by pumping it into the circulating channel that circulates in the fuel cell 10. The cooling temperature of the fuel cell 10 can be controlled by controlling the revolution speed of this water pump 53 to adjust the flow of the coolant.

The fuel cell 10 is connected to a high voltage battery 22 as the electrical storage device, a drive motor 23, and the auxiliary device 50 through a voltage control unit (VCU) 21. Electric power produced in the fuel cell 10 is supplied to the high voltage battery 22, the drive motor 23, and the auxiliary device 50. The voltage control unit 21 limits output power from the fuel cell 10 and supplies the electric power to the high voltage battery 22, the drive motor 23, and the auxiliary device 50 based on a control command from the control device 70.

The high voltage battery 22 is configured by a secondary cell such as a lithium ion cell. When the voltage of the high voltage battery 22 is lower than that of the fuel cell 10, the high voltage battery 22 stores output power from the fuel cell 10. In addition, the high voltage battery 22 supplies electric power to the drive motor 23 and the auxiliary device 50 as required to assist the fuel cell 10 in electric power production as being connected to the drive motor 23 and the auxiliary device 50 through the voltage control unit 21.

The high voltage battery 22 connects to the battery electric power sensor 224 as the electric power detection means for detecting the electric power (W5) output from the high voltage battery 22. Specifically, this battery electric power sensor 224 is configured by including a battery voltage sensor 221 as the voltage detection means for detecting the out voltage (V5) of the high voltage battery 22, and a battery current sensor 222 detecting the output current I5 of the high voltage battery 22. In addition, the high voltage battery 22 is provided with the battery temperature sensor 223 as the electrical storage device temperature detection means for detecting the electric power (T5) of the high voltage battery 22.

The control device 70 is connected to the abovementioned voltage control unit 21, the high voltage battery 22, the drive motor 23, the ejector 33, the auxiliary device 50, the back pressure valve 421, the air release valve 431, the isolation valve 451, the purge valve 461, and the like. In addition, although not shown in this figure, the control device 70 is also connected to sensors such as the fuel cell voltage sensor 101, the fuel cell current sensor 102, the battery power sensor 224, the battery temperature sensor 223, the air discharge channel temperature sensor 422, the air supply channel pressure sensor 412, the air supply channel flow sensor 413, the hydrogen discharge channel temperature sensor 462, and the auxiliary device power consumption sensor 501.

The control device 70 can control the supply device 30 and the auxiliary device 50 to startup the fuel cell 10 to produce electric power. The procedure by which the control device 70 controls the supply device 30 the fuel cell 10 to produce electric power by the fuel cell 10 is described below.

Hydrogen gas is supplied from the hydrogen tank 32 to the anode side of the fuel cell 10 through the hydrogen supply channel 45 while the purge valve 461 is closed. In addition, air is supplied to the cathode side of the fuel cell 10 through the air supply channel 41 by driving the air compressor 31.

Hydrogen gas and air supplied to the fuel cell 10 are used for electric power production, and then flow into the hydrogen discharge channel 46 and the air discharge channel 42, along with residual water such as water generated on the anode side. At this time, since the purge valve 461 is closed, hydrogen gas discharged from the fuel cell 10 flows into the recirculation channel 47, and then flows back to the ejector 33, thereby being supplied to the fuel cell 10 again.

Afterwards, hydrogen gas and air are discharged from the hydrogen discharge channel 46 and the air discharge channel 42 through an emission gas process device, by controlling opening and closing of the purge valve 461 and the back pressure regulating valve 421 at the appropriate rate, and the opening of these valve.

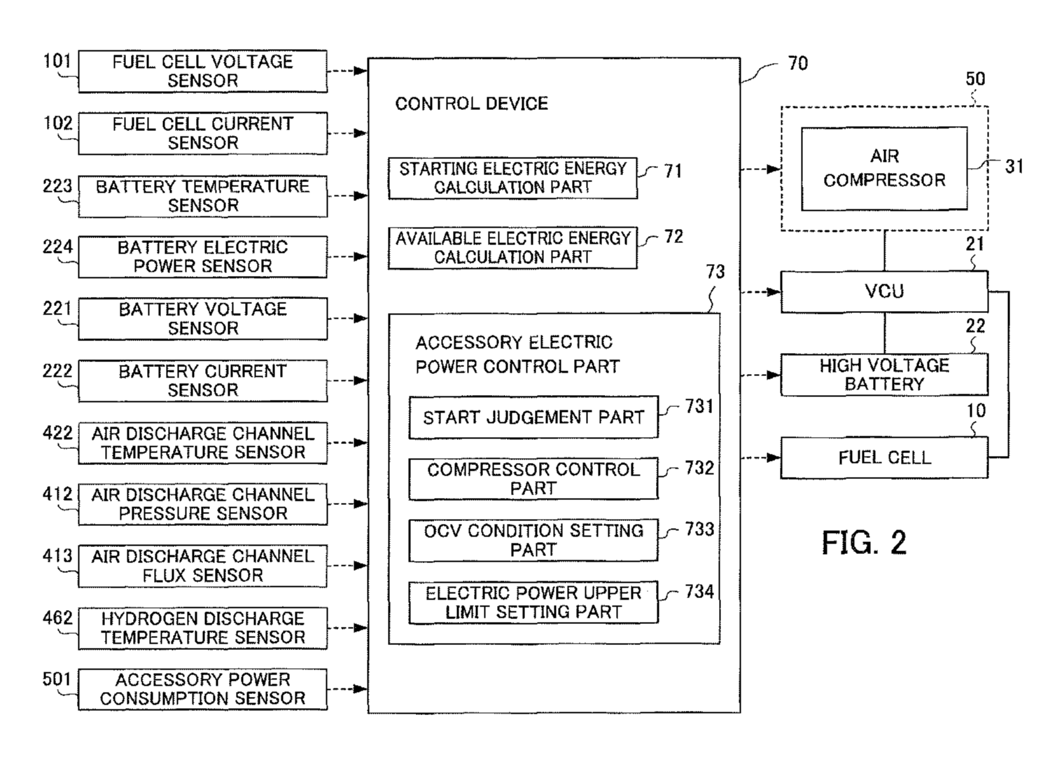

FIG. 2 shows a block diagram of the control device 70 illustrating the control device 70 on startup of the fuel cell 10. More specifically, this block diagram illustrates the control device 70 on performing of the OCV check when the fuel cell 10 is started.

The control device 70 is provided with the startup electric power calculation portion 71 calculating an amount of electric power required for startup of the fuel cell 10, the available electric power calculation portion 72 calculating an amount of the available electric power of the high voltage battery 22, and the auxiliary device electric power control device 73 controlling electric power consumed by the auxiliary device 50 when the fuel cell 10 is start up.

The startup electric power calculation portion 71 calculates the amount of the startup electric power which is the amount of electric power required for supplying to the auxiliary device 50 to perform the OCV check when the fuel cell 10 is startup.

The available electric power calculation portion 72 calculates the state-of-charge (SOC) of the high voltage battery 22 based on input power from the battery voltage sensor 221, the battery current sensor 222, etc., and then calculates the amount of available electric power of the high voltage battery 22 based on this state-of-charge. Specifically, the available electric power calculation portion 72 is provided with a control map for calculating the amount of available electric power by using the state-of-charge and the battery temperature of the high voltage battery 22 as input values, and the available electric power calculation portion 72 calculates the amount of available electric power of the high voltage battery 22 by this control map. The available electric power denotes electric power available from the high voltage battery 22.

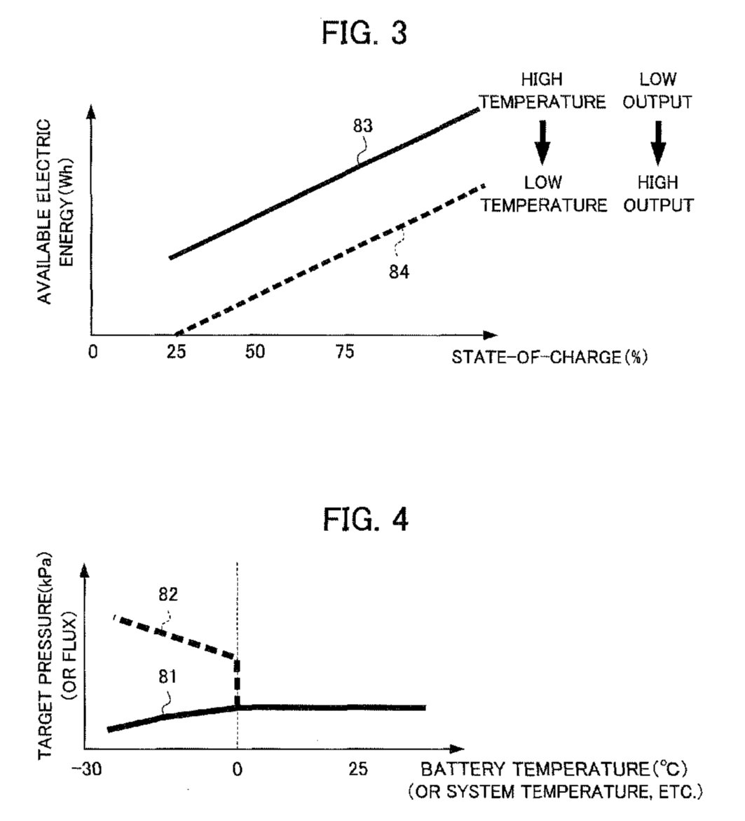

FIG. 3 shows a graph illustrating the relationship between the state-of-charge and the amount of available electric power of the high voltage battery 22, as well as the control map of the available electric power calculation portion 72. In FIG. 3, the continuous line 83 and the broken line 84 show the relationship between the state-of-charge and the amount of available electric power of the high voltage battery 22 at different temperatures. The broken line 84 shows the relationship between the state-of-charge and the amount of available electric power of the high voltage battery 22 at lower temperature than the continuous line 33.

As shown by the continuous line 83 and the broken line 84, the amount of available electric power is set to a smaller value as the state-of-charge of the high voltage battery 22 decreases. In addition, the available electric power is set to a smaller value as the temperature of the high voltage battery 22 decreases.

Furthermore, the available electric power calculation portion 72 can calculate the amount of available electric power by using the target output power of the high voltage battery 22, (i.e., target power consumption in the auxiliary device 50) as an input value, in addition to the state-of-charge and the battery temperature of the high voltage battery 22. In other words, when the power consumption in the auxiliary device 50 increases, the consumption due to the internal resistance of the high voltage battery 22 is increased. Thus, the electric power available from the high voltage battery 22 is decreased. Accordingly, the available electric power calculation portion 72 sets the available electric power to a smaller value, as the target output power of the high voltage battery 22 increases.

The auxiliary device electric power control device 73 is provided with a start judgment portion 731, a compressor control portion 732, an OCV condition setting portion 733, and an electric power upper limit setting portion 734. Upon starting up the fuel cell 10, the auxiliary device electric power control device 73 controls the isolation valve 451 and the purge valve 461, and then performs the OCV check of the fuel cell 10 while electric power of the high voltage battery 22 is supplied to auxiliary device 50.

The start judgment portion 731 judges whether or not the fuel cell 10 can startup, based on the amount of startup electric power calculated by the startup electric power calculation portion 71, and the amount of available electric power calculated by the available electric power calculation portion 72. Specifically, the start judgment portion 731 judges whether it is possible to startup the fuel cell 10 supplying the electric power to the auxiliary device 50 when the amount of available electric power is greater than the amount of startup electric power, and whether it is impossible to startup the fuel cell 10 when the amount of available electric power is not greater than the amount of the startup electric power.

The compressor control portion 732 controls the opening of the isolation valve 451 and the purge valve 461, and then performs the OCV check while the electric power of the high voltage battery 22 is supplied to the air compressor 31 of the auxiliary device 50, based on a control condition set by the OCV condition setting portion 733 and the electric power upper limit setting portion 734. Specifically, the compressor control portion 732 controls the electric power to be supplied to the air compressor 31 so that the pressure in the air supply channel 41 is the target pressure set by the OCV condition setting portion 733. Furthermore, the compressor control portion 732 controls the electric power to be supplied to the air compressor 31 so that the electric power W5 detected by the battery electric power sensor 224 is less than the upper limit of electric power set by the electric power upper limit setting portion 734.

The OCV condition setting portion 733 sets a target pressure in the air supply channel 41 at the time of the OCV check, based on the temperature T5 of the high voltage battery 22 detected by the battery temperature sensor 223. Specifically, the OCV condition setting portion 733 is provided with the control map and sets the target pressure in the air supply channel 41 depending on the temperature of the high voltage battery 22 based on this control map. As described below, the OCV condition setting portion 733 sets the target pressure in the air supply channel 41, but it may set the target flow of air in the air supply channel 41. As described below, the input value for setting the target pressure is employed as the battery temperature of the high voltage battery 22, but may also be employed as the temperature of the fuel cell system 1.

FIG. 4 shows a graph illustrating the relationship between the temperature of the high voltage battery 22 and the target pressure in the air supply channel 41, as well as the control map of the OCV condition setting portion 733. As shown in the continuous line 81 in FIG. 4, the target pressure in the air supply channel 41 (i.e., the cathode target pressure) is set to be smaller as the temperature of the high voltage battery 22 decreases. Specifically, according to this control map, when the temperature of the high voltage battery 22 exceeds 0° C., the cathode target pressure is set to a substantially constant value despite the temperature of the high voltage battery 22. On the other hand, when the temperature of the high voltage battery 22 is 0° C. or less, the cathode target pressure is set to be smaller as the temperature of the high voltage battery 22 decreases. In other words, according to this control map, the electric power to be supplied to air compressor 31 is set to a smaller value as the temperature of the high voltage battery 22 decreases. Accordingly, the high voltage battery increases the limit of electric power to be supplied to air compressor 31 as the temperature of the high voltage battery 22 decreases.

In addition, the air supply channel 41 and the hydrogen supply channel 45 are connected through the air connection channel 43 and the regulator 34. Thus, the pressure of gas in the hydrogen supply channel 45 (i.e., the anode pressure) is varied with the cathode pressure. The condition set by the OCV condition setting portion 733 may be based on the target flow of air in the air supply channel 41 without limiting the cathode target pressure.

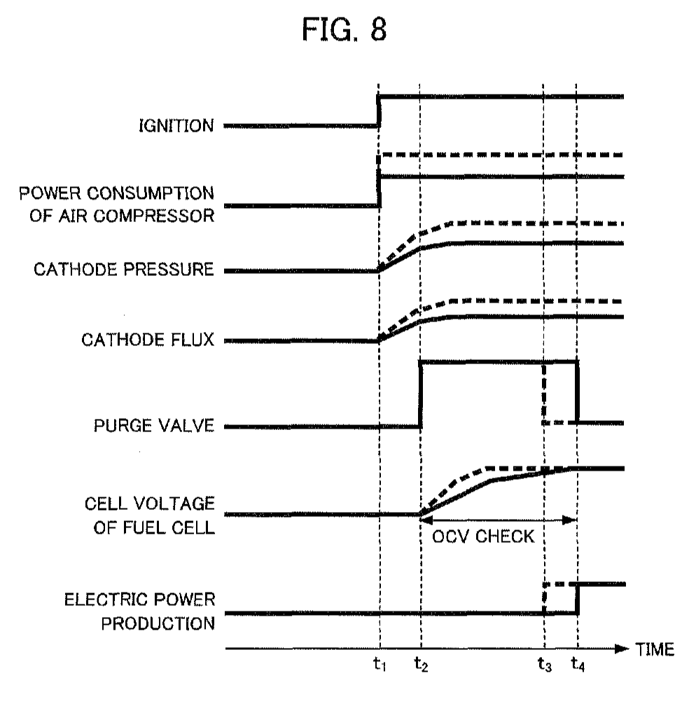

The broken line 82 in FIG. 4 represents the relationship between the temperature of the high voltage battery and the cathode target pressure in a conventional fuel cell system. According to this conventional fuel cell system, when the temperature of the battery is 0° C. or less, the target pressure is set to a larger value than in the case of a normal temperature of 0° C. or more. A comparison with the fuel cell system 1 of this embodiment and this conventional fuel cell system is described with reference to FIG. 8.

Referring back to the FIG. 2, the electric power upper limit setting portion 734 sets the upper limit of electric power to be supplied to the auxiliary device 50 at the time of the OCV check, based on the temperature T5 of the high voltage battery 22 detected by the battery temperature sensor 223. Specifically, the electric power upper limit setting portion 734 is provided with the control map and sets the upper limit of the electric power to be supplied to the auxiliary device 50 depending on the temperature of the high voltage battery 22 based on this control map.

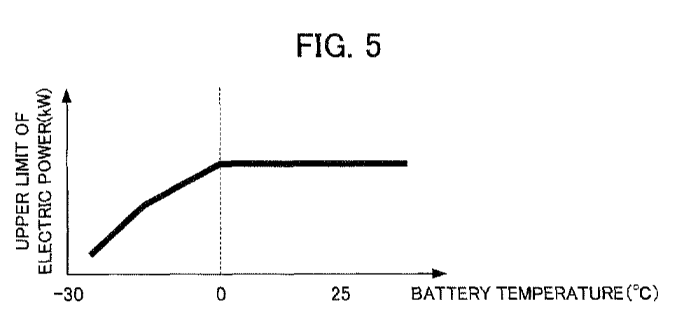

FIG. 5 shows a graph illustrating the relationship between the temperature of the high voltage battery 22 and the upper limit of the electric power to be supplied to the auxiliary device 50, as well as the control map of the electric power upper limit setting portion 734. As shown in FIG. 5, the upper limit of the electric power to be supplied to the auxiliary device 50 is set to be smaller as the temperature of the high voltage battery 22 decreases. Specifically, according to this control map, when the temperature of the high voltage battery 22 exceeds 0° C., the upper limit of electric power to be supplied to the auxiliary device 50 is set by approximately substantially constant value despite the temperature of the high voltage battery 22.

On the other hand, when the temperature of the high voltage battery 22 is 0° C. or less, the upper limit of electric power to be supplied to the auxiliary device 50 is set to be smaller as the temperature of the high voltage battery 22 decreases. The upper limit of the electric power is set to a value so that the voltage of the high voltage battery 22 is at least the minimum required lower limit due to the abovementioned IR drop shown in FIG. 12.

An ignition switch (not shown) is connected to the control device 70. The ignition switch is provided on the driver's side of a fuel-cell vehicle, and it transmits on/off signals to the control device 70 according to the driver's operation. The control device 70 starts the fuel cell 10 in response to an on signal indicating that the ignition switch is turned on. The control device 30 stops the fuel cell 10 in response to an off signal indicating that the ignition switch is turned off.

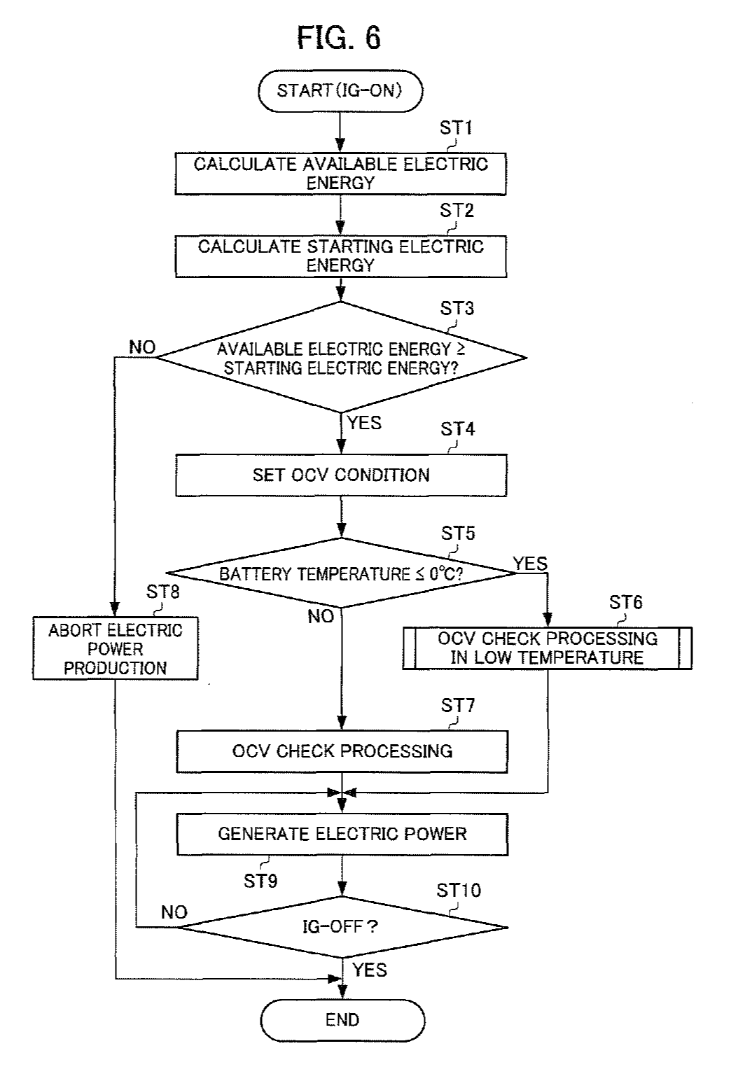

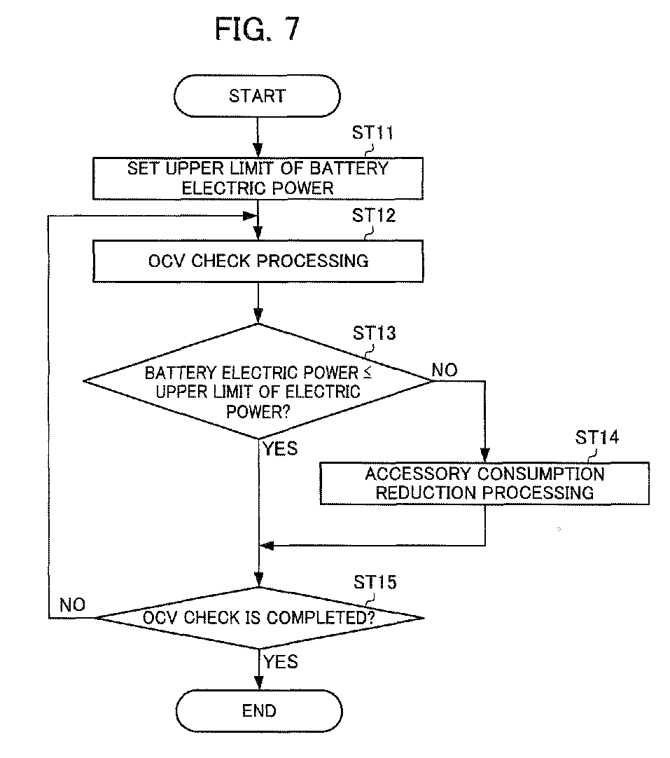

The operation of the aforementioned fuel cell system 1 is now described with reference to the flowcharts of FIGS. 6 and 7.

FIG. 6 is a flowchart showing the procedure from startup to stop of the fuel cell 10.

The fuel cell 10 is startup based on whether the ignition switch is turned on. In ST1, the amount of available electric power of the high voltage battery 22 is calculated by the available electric power calculation portion 72, and then the process moves to ST2. More specifically, in this step, the amount of available electric power is calculated based on the state-of-charge and the temperature T5 of the high voltage battery 22 detected by the battery temperature sensor 223. In ST2, the startup electric power calculation portion 71 calculates the amount of startup electric power required to supply the auxiliary device 50 to perform the OCV check, and then the process moves to ST3.

In ST3, the startup judgment portion 731 judges whether or not the amount of available electric power is greater than or equal to the amount of startup electric power. If the judgment is “YES”, then the process moves to ST4. On the other hand, if the judgment is “NO”, then the fuel cell 10 aborts electric power production (ST8), and the startup of the fuel cell 10 is terminated. In ST4, the OCV condition is set, and then the process moves to ST5. More specifically, in this step, the OCV condition setting portion 733 sets the cathode target pressure depending on the temperature of the high voltage battery 22 (see FIG. 4).

In ST5, the auxiliary device electric power control portion 73 judges whether the temperature T5 of the high voltage battery 22 detected by the battery temperature sensor 223 is 0° C. or less. If the judgment is “YES”, then the process moves to ST6. If the judgment is “NO”, then the process moves to ST7. In ST6, the OCV check processing for low temperature as described below with reference to FIG. 7 is performed, and then the process moves to ST9.

In ST7, the OCV process is performed, and then the process moves to ST9. Specifically, the compressor control portion 732 opens the isolation valve 451 and the purge valve 461 while the electric power is supplied to the air compressor 31 so that the pressure P3 in the air supply channel 41, which is detected by the air supply channel pressure sensor 412, is the set target pressure. At this time, the OCV check processing is performed until the voltage V1 of fuel cell 10 detected by the fuel cell voltage sensor 101 reaches the predetermined value.

In ST9, the fuel cell 10 produces electric power, and then the process moves to ST10. More specifically, in this step, the electric power of the fuel cell 10 is supplied to the drive motor 23 while the power source supplying electric power to the auxiliary device 50 is switched from the high voltage battery 22 to the fuel cell 10. In addition, according to the abovementioned procedure, the supply device 30 is controlled to produce electric power by the fuel cell 10. In ST10, it is judged whether or not the ignition switch is turned off (ST11). If the judgment is “YES”, then electric power production is terminated. If the judgment is “NO”, then the process moves to ST9.

FIG. 7 is a flow chart showing the procedure of the OCV check processing for low temperature.

At first, in ST11, the upper limit of the electric power of the high voltage battery 22 is set, and then the process moves to ST12. More specifically, in this step, the electric power upper limit setting portion 734 sets the upper limit of electric power to be supplied to the auxiliary device 50 depending on the temperature T5 of the high voltage battery 22 (see FIG. 4).

In ST12, the OCV check processing is performed, and then the process moves to ST13. Specifically, the compressor control portion 732 opens the isolation valve 451 and the purge valve 461 while electric power is supplied to the air compressor 31 so that the pressure P3 in the air supply channel 41, which is detected by the air supply channel pressure sensor 412, is the set target pressure. In ST13, it is judged whether or not electric power to be supplied to the auxiliary device 50 is not greater than the set upper limit. If the judgment is “YES”, then the process moves to ST15. If the judgment is “NO”, then the process moves to ST14.

In ST14, auxiliary device consumption reduction processing is performed, and then the process moves to ST15. In the auxiliary device consumption reduction processing, resetting of the OCV condition is performed so that power consumption by the auxiliary device 50 is reduced. More specifically, the target pressure in the air supply channel 41 set in abovementioned ST4 is reset to a smaller value. In ST15, it is judged whether or not the OCV check has been completed, and if the judgment is “YES”, then the process moves to ST9, whereas if the judgment is “NO”, then the process moves to ST12. More specifically, in this step, it is judged whether or not the cell voltage of the fuel cell 10 has reached the predetermined value.

The performances of the fuel cell system 1 of this embodiment and a conventional fuel cell system are compared by using the timing chart shown in FIG. 8. FIG. 8 shows an example of a timing chart when these fuel cell systems are started below the freezing point. In addition, the conventional fuel cell system indicates a fuel cell system that starts its fuel cell at the target pressure represented by the broken line 82 in FIG. 4.

At time t1, when the ignition switch is turned on, the supply of electric power to the air compressor 31 begins. In addition, by beginning a supply of air by way of the compressor 31, the pressure (cathode pressure) in the air supply channel begins to be increased. The flow of air in the air supply channel 41 (cathode flow) also begins to be increased as the cathode pressure increases.

At time t2, when the purge valve 461 is opened, gas retained in the anode channel begins to be discharged. In addition, the cell voltage of the fuel cell 10 begins to be increased in accordance with this gas discharge.

At time t3, in the conventional fuel cell system represented by the broken lines, the cell voltage of the fuel cell reaches the predetermined value, whereby the OCV check is completed, the purge valve is closed, and then the power generation is started.

At time t4, in the fuel cell system of this embodiment represented by the continuous lines, the cell voltage of the fuel cell 10 reaches the predetermined value, upon which the OCV check is completed, the purge valve is closed, and then the power generation is started.

As described above, in the fuel cell system 1 of this embodiment, the cathode target pressure in the air supply channel 41 is set to be smaller as the temperature of the high voltage battery 22 decreases. Thus, as shown in FIG. 8, the cathode pressure in the fuel cell system of this embodiment is lower than the cathode pressure in a conventional fuel cell system. Accordingly, it takes longer to complete the OCV check; however, the power consumption of the air compressor 31 can be decreased.

The above-described embodiments of the present invention have the following advantages.

(1) According to the fuel cell system 1 of this embodiment, based on the temperature of or around the high voltage battery 22, the fuel cell system is provided with the auxiliary device electric power control portion 73 for limiting electric power consumed in auxiliary device 50 to startup the fuel cell 10. For example, when the temperature of the high voltage battery 22 is below the freezing point, the auxiliary device 50 is driven within the range of the amount of electric power available in the high voltage battery 22, by limiting electric power consumed in auxiliary device 50 by the auxiliary device electric power control portion 73, so that the fuel cell system 1 can be started up reliably.

(2) According to the fuel cell system 1 of this embodiment, electric power consumed by the auxiliary device 50 is controlled by the auxiliary device electric power control portion 73 so that electric power consumed by the auxiliary device 50 is less than the upper limit of electric power set based on the temperature of the high voltage battery 22. For example, in a case where the temperature of the high voltage battery 22 is below the freezing point, the fuel cell system 1 can be started up reliably by setting the upper limit of voltage so that the voltage of the high voltage battery 22 is not lower than the lower limit required for at least starting up the fuel cell system 1.

(3) According to the fuel cell system 1 of the present invention, based on the temperature of or around the high voltage battery 22, the auxiliary device electric power control portion 73 limits electric power consumed by the air compressor 31 supplying hydrogen gas. Accordingly, in a case where hydrogen gas is supplied when the fuel cell system 1 is started below the freezing point, it takes longer to startup the fuel cell system 1 compared to a case where electric power is not limited. However, the auxiliary device can be driven within the range of the amount of electric power available in the high voltage battery 22 to startup the fuel cell system 1 reliably. In addition, noise which may be generated when the air compressor 31 is driven can be reduced by limiting electric power consumed by the air compressor 31.

### Second Embodiment

In order to omit or simplify the explanation of the following embodiments, the same elements are indicated by the same numerals.

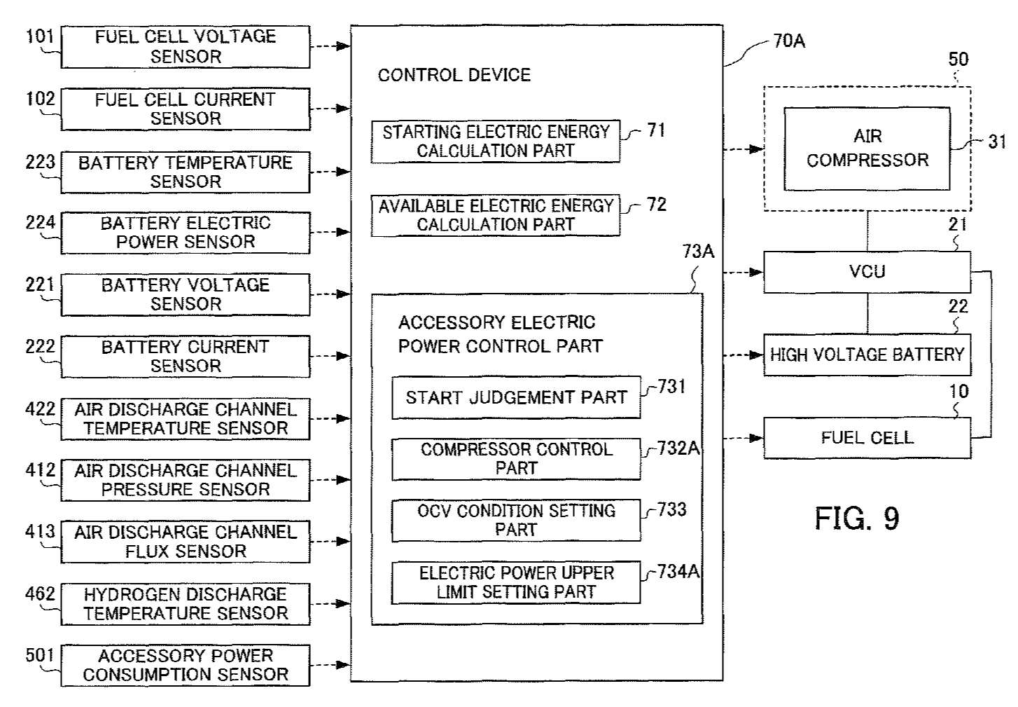

FIG. 9 is a block diagram of the control device 70A in the fuel cell system 1 according to a second embodiment of the present invention.

As shown in FIG. 9, the fuel cell system of the second embodiment differs from the fuel cell system of the first embodiment in that the structure of the auxiliary device electric power control portion 73A of the control device 70A. Specifically, the auxiliary device electric power control device 73A is provided with a start judgment portion 731, a compressor control portion 732A, an OCV condition setting portion 733, and a voltage lower limit setting portion 734A.

In the fuel cell system 1 of the first embodiment, electric power is supplied to the auxiliary device 50 so that electric power drawn from the high voltage battery 22 does not exceed the upper limit of electric power set by the electric power upper limit setting portion 734. On the other hand, in the fuel cell system of the second embodiment, electric power is supplied to the auxiliary device 5D so that the voltage of the high voltage battery 22 is not lower than the lower limit of voltage set by the voltage lower limit setting portion 734A. The fuel cell systems of the first embodiment and the second embodiment differ in these points.

Specifically, the voltage lower limit setting portion 734A sets the lower limit of the voltage of the high voltage battery 22 at the time of the OCV check, based on the temperature T5 of the high voltage battery 22 detected by the battery temperature sensor 223. Specifically, the voltage lower limit setting portion 734A is provided with the control map and sets the lower limit of the voltage of the high voltage battery 22 depending on the temperature of the high voltage battery 22 based on this control map.

The compressor control portion 732A supplies voltage of the high voltage battery 22 to the air compressor 31 of the auxiliary device 50, based on a control condition set by the OCV condition setting portion 733 and the voltage lower limit setting portion 734A, and then performs the OCV check. Specifically, the compressor control portion 732A controls the electric power to be supplied to the air compressor 31 so that the pressure P3 in the air supply channel 41 detected by the air supply channel pressure sensor 412 is the target pressure set by the OCV condition setting portion 733. Furthermore, the compressor control portion 732 controls the electric power to be supplied to the air compressor 31 so that the voltage V5 detected by the battery voltage sensor 221 is larger than the value of the voltage lower limit set by the voltage lower limit setting portion 734A.

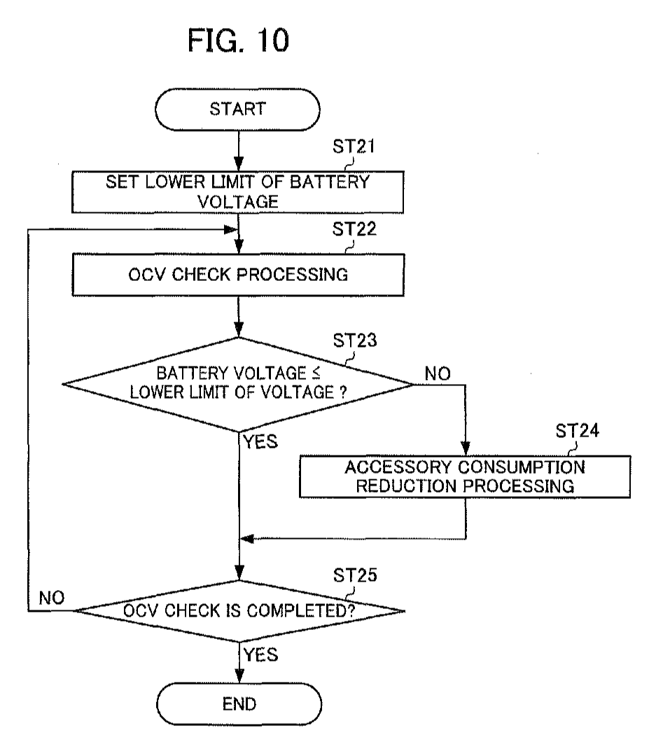

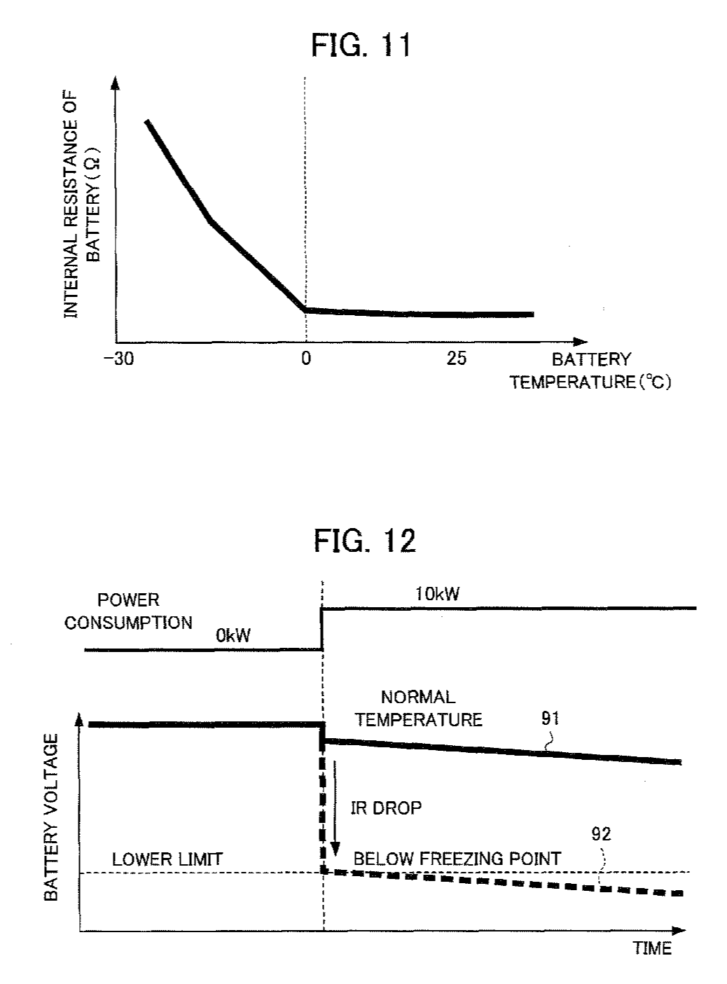

FIG. 10 is a flow chart showing the procedure of the OCV check processing for low temperature in the second embodiment.

At first, in ST21, the lower limit of the voltage of the high voltage battery 22 is set, and then the process moves to ST22. More specifically, in this step, the voltage lower limit setting portion 734A sets the lower limit of the voltage of the high voltage battery 22 depending on the temperature of the high voltage battery 22 (see FIG. 4).

In ST22, the OCV check processing is performed, and then the process moves to ST23. Specifically, the compressor control portion 732A supplies electric power to the air compressor 31 so that the pressure PS in the air supply channel 41, which is detected by the air supply pressure sensor 412, is the set target pressure. In ST23, it is judged whether or not the voltage of the high voltage battery 22 is equal to or more than the set lower limit. If the judgment is “YES”, then the process moves to ST25. If the judgment is “NO”, then the process moves to ST24.

In ST24, auxiliary device consumption reduction processing is performed, and then the process moves to ST25. In the auxiliary device consumption reduction processing, resetting of the OCV condition is performed so that power consumption by the auxiliary device 50 is reduced. Specifically, the target pressure in the air supply channel 41 set in the abovementioned ST4 is reset to a smaller value. In ST25, it is judged whether or not the OCV check has been completed. If the judgment is “YES”, then the OCV check processing for low temperature is finished. If the judgment is “NO”, then the process moves to ST22. More specifically, in this step, it is judged whether or not the cell voltage of the fuel cell 10 has reached the predetermined value.

The above-described embodiment of the present invention has the following advantage in addition to that of the abovementioned first embodiment.

(4) According to the fuel cell system of this embodiment, electric power consumed in the auxiliary device 50 is controlled by the auxiliary device electric power control portion 73 so that electric power consumed in the auxiliary device 50 is lower than the upper limit of electric power set based on the temperature of the high voltage battery 22. For example, when the temperature of the high voltage battery 22 is below the freezing point, the fuel cell system 1 can be started up reliably by setting the upper limit of electric power so that the voltage of the high voltage battery 22 is at least the lower limit required to start up the fuel cell system 1 when the fuel cell is startup.

The present invention is not to be considered to be limited by the foregoing description and/or the appended claims.

In the fuel cell systems of the first and second embodiments, the temperature of the high voltage battery 22 is detected directly by being provided with the battery temperature sensor 223, as the electrical storage device temperature detection means, but is not limited thereto. The temperature of the high voltage battery may be estimated based on the temperature detected, for example, as the temperature of the fuel cell, the auxiliary device, the fuel cell system, or the like.

In addition, in the fuel cell systems of the first and second embodiments, the target pressure in the air supply channel 41 at the time of the OCV check is set based on the temperature of the high voltage battery 22 detected by the battery temperature sensor 223r but is not limited thereto. The target pressure may be estimated based on the temperature around the high voltage battery of the fuel battery system, or the like.

In addition, in the fuel cell systems of the first and second embodiments, the amount of available electric power is calculated based on the state-of-charge and the temperature of the high voltage battery 22, but is not limited thereto. The amount of available electric power may be calculated depending on the target output of the high voltage battery (i.e., electric power consumption of the auxiliary device 50), in addition to the state-of-charge and the temperature of the high voltage battery.

Furthermore, in the fuel cell systems of the first and second embodiments, the OCV condition setting portion 733 sets the target pressure in the air supply channel 41, but is not limited thereto. For example, the target flow of air in the air supply channel may be set.

What is claimed is:

1. A fuel cell system comprising: a fuel cell producing electric power by the reaction of reactive gas;
an auxiliary device driving the fuel cell;
an electrical storage device storing at least a portion of the electric power produced in the fuel cell;
a control means for supplying the electric power stored in the electrical storage device to the auxiliary device to startup the fuel cell when the fuel cell is started; and
an electrical storage device temperature detection means for one of detecting and estimating a temperature of the electrical storage device;
wherein the control means comprises:
a startup electric power calculation means for calculating an amount of startup electric power which is an amount of electric power required for the auxiliary device to startup the fuel cell;
an available electric power calculation means for calculating an amount of available electric power which is an amount of electric power available from the fuel cell; and
an auxiliary device electric power control means for judging whether or not the amount of available electric power exceeds the amount of startup electric power, supplying the electric power to the auxiliary device to startup the fuel cell when the amount of available electric power is greater than the amount of startup electric power, and cancelling startup of the fuel cell when the amount of available electric power is not greater than the amount of startup electric power;
wherein the auxiliary device electric power control means limits the electric power to be supplied to the auxiliary device based on the temperature detected by the electrical storage device temperature detection means in case where the fuel cell is started.

2. The fuel cell system according to claim 1, further comprising:
an electric power detection means for detecting electric power output from the electrical storage device;
wherein the auxiliary device control means sets an upper limit of electric power based on the temperature detected by the electrical storage device temperature detection means, and controls the electric power to be supplied to the auxiliary device so that the electric power detected by the electric power detection means is less than the upper limit of electric power.

3. The fuel cell system according to claim 1, further comprising:
a voltage detection means for detecting a voltage of the electrical storage device;
wherein the auxiliary device electric power control means controls the electric power to be supplied to the auxiliary device so that the voltage detected by the voltage detection means is greater than a predetermined lower limit of voltage.

4. The fuel cell system according to claim 1, wherein the auxiliary device comprises a reactive gas supply means for supplying reactive gas.

5. The fuel cell system according to claim 1, wherein the electrical storage device temperature detection means detects a temperature of one of the fuel cell and the auxiliary device, and estimates the temperature of the electrical storage device based on the detected temperature.

6. A method for controlling a fuel cell system having
a fuel cell producing electric power by a reaction of reactive gas,
an auxiliary device driving the fuel cell,
an electrical storage device storing at least a portion of the electric power produced by way of the fuel cell, and
a control means for supplying the electric power stored in the electrical storage device to the auxiliary device to startup the fuel cell when the fuel cell is started, the method comprising:
a startup electric power calculation step of calculating an amount of startup electric power which is an amount of electric power required for the auxiliary device to startup the fuel cell;
an available electric power calculation step of calculating an amount of available electric power which is an amount of electric power available from the fuel cell; and
an auxiliary device electric power control step of judging whether or not the amount of available electric power exceeds the amount of startup electric power, supplying the electric power to the auxiliary device to startup the fuel cell in a case where the amount of available electric power is greater than the amount of startup electric power, and cancelling startup of the fuel cell when the amount of available electric power is not greater than the amount of startup electric power;
wherein the auxiliary device electric power control means limits the electric power to be supplied to the auxiliary device based on a temperature of the electrical storage device in a case where the fuel cell is startup.
